(19) United States
(12) Patent Application Publication
(10) Pub. No.: US 2023/0033371 A1
(43) Pub. Date: Feb. 2, 2023

(54) ILLUMINATING UMBRELLA

(71) Applicant: Xiamen Mingho Brothers MFG Co., Ltd, Xiamen (CN)

(72) Inventors: Shun-Jung Chen, Xiamen (CN); Sun-Feng Sung, Xiamen (CN); Ming-Hsiung Chen, Xiamen (CN)

(21) Appl. No.: 17/388,019

(22) Filed: Jul. 29, 2021

(51) Int. Cl. A45B 3/04; F21V 23/04; F21S 4/20; F21V 23/00

(52) U.S. Cl. CPC A45B 3/04; F21V 23/04; F21S 4/20; F21V 23/003; A45B 2200/1018; A45B 2200/1081

(57) ABSTRACT

An illuminating umbrella includes an umbrella body and an illuminating device. An illuminating body of the illuminating device is fitted to a shaft of the umbrella body. A lower hub of the umbrella body movably presses a main switch of the illuminating device for controlling the illuminating body to illuminate or not to illuminate. The illuminating umbrella provides an illuminating function for the user to view the surrounding environment and articles in an environment with insufficient light. The illuminating body is automatically turned on when the umbrella is unfolded, and the illuminating body is automatically turned off when the umbrella is folded. It is convenient to use.

### BACKGROUND OF THE INVENTION

### 1. Field of the Invention

The present invention relates to are umbrella, and more particularly to an illuminating umbrella.

### 2. DESCRIPTION OF THE PRIOR ART

A conventional umbrella has a single function, without are illuminating function. If the umbrella is used in a dark environment, the user needs to take a flashlight for illuminating. It is very inconvenient for the user to walk and hold the umbrella with one hand and the flashlight with the other hand. This may affect the safety of the user.

### SUMMARY OF THE INVENTION

The primary object of the present invention is to provide an illuminating umbrella, which has an illuminating function and is convenient for use.

In order to achieve the above object, the present invention adopts the following technical solutions:

An illuminating umbrella comprises an umbrella body and are an illuminating device. The umbrella body includes a shaft, an upper hub fixed to an upper end of the shaft, a lower hub movably fitted to the shaft, an umbrella handle fixed to a lower end of the shaft, and an umbrella frame hingedly connected to the upper hub and the lower hub. The illuminating device includes an illuminating body, a main switch for controlling the illuminating body to Mate or not to illuminate, and a battery for supplying power to the illuminating body. The illuminating body is fitted to the shaft.

Preferably, the illuminating body includes a light holder and an illuminating light fitted to the light holder. The light holder is fitted to the shaft. The main switch controls the illuminating light of the illuminating body to illuminate or not to illuminate. The battery is configured to supply power to the illuminating light of the illuminating body.

Preferably, the light holder of the illuminating body is fixed to the shaft, and the light holder is located between the upper hub and the lower hub.

Preferably, the main switch is fitted to the umbrella body. The lower hub of the umbrella body movably presses the main switch for controlling the main switch to be connected or disconnected. The main switch is a tact switch. Connection or disconnection of the main switch controls the illuminating body to illuminate or not to illuminate.

Preferably, the illuminating device further includes a controller. The controller is electrically connected to the illuminating body and the main switch. The battery supplies power to the controller. The controller controls the illuminating body to illuminate or not to illuminate according to connection or disconnection of the main switch.

Preferably; the illuminating device further includes a secondary switch. The secondary switch is electrically connected to the controller. The controller controls the illuminating body to illuminate or not to illuminate according to connection or disconnection of the secondary switch.

With the above solutions, the present invention has the following advantages:

1. The illuminating umbrella of the present invention provides an illuminating function by providing an illuminating device, which is convenient for the user to use the umbrella in an environment with insufficient light.

2. The main switch of the illuminating device is movably pressed by the lower hub for controlling the main switch to be connected or disconnected. The connection or disconnection of the main switch is to control the illuminating body of the illuminating device to illuminate or not to illuminate. In this way, the illuminating body of the present invention is automatically turned on when the umbrella is unfolded, and the illuminating body is automatically turned off when the umbrella is folded. It is convenient to use, 3. The illuminating body of the present invention is fitted to the shaft. After the illuminating umbrella of the present invention is unfolded, the illuminating body can illuminate the space under the umbrella frame, so that the user can view articles when the umbrella is used in an environment with insufficient light.

### BRIEF DESCRIPTION OF THE DRAWINGS

FIG. 1 is a schematic view of the illuminating umbrella in an unfolded state of present invention;

FIG. 2 is a schematic view of the illuminating umbrella in a folded state of the present invention;

FIG. 3 is a partial cross-sectional view of the illuminating umbrella an unfolded state of the present invention;

FIG. 4 is an enlarged view of circle A of FIG. 3;

FIG. 5 is a partial cross-sectional view of the illuminating umbrella in a folded state of the present invention;

FIG. 6 is an enlarged view of circle B of FIG. 5;

FIG. 7 is a schematic view of the illuminating device of the illuminating umbrella of the present invention;

FIG. 8 is an exploded view of the main switch of the present invention;

FIG. 9 is a cross-sectional view of the main switch of the present invention;

FIG. 10 is a schematic vie r of the secondary switch and the button of the present invention; and

FIG. 11 is a schematic view of the circuit structure of the control circuit board of the present invention.

### DETAILED DESCRIPTION OF THE PREFERRED EMBODIMENTS

Embodiments of the present invention will now be described, by way of example only with reference to the accompanying drawings.

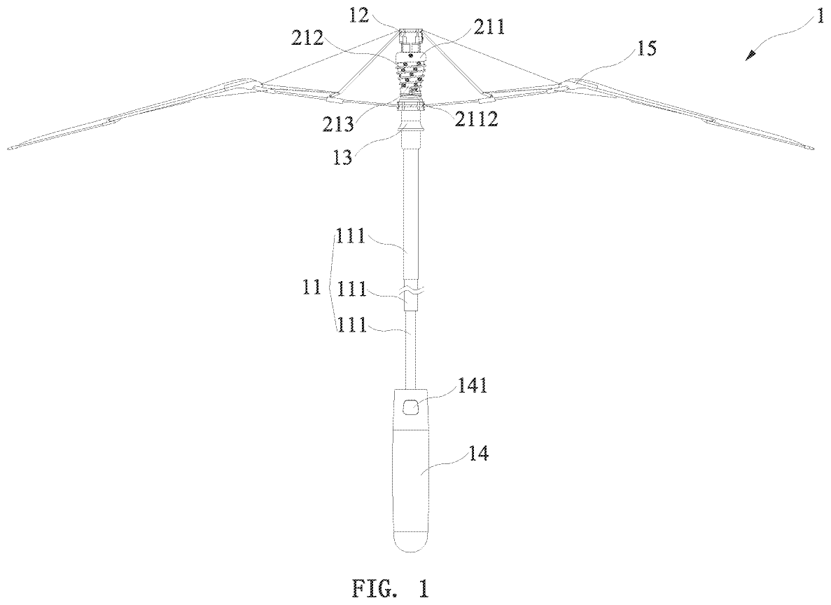

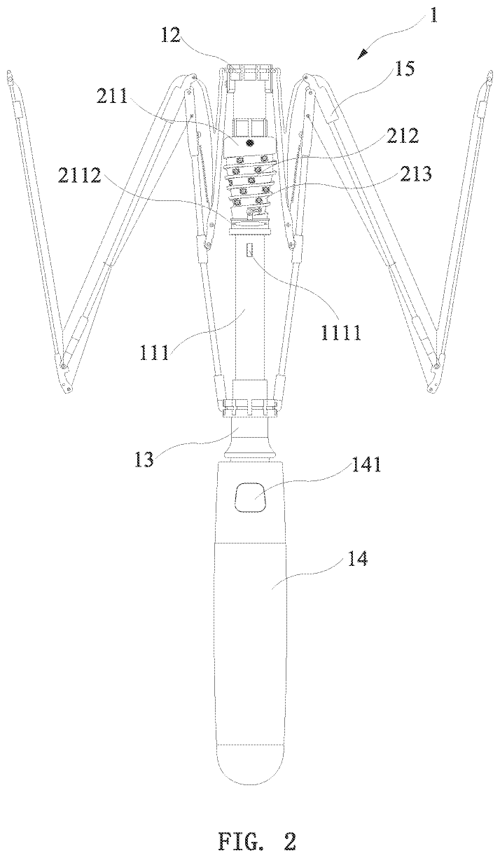

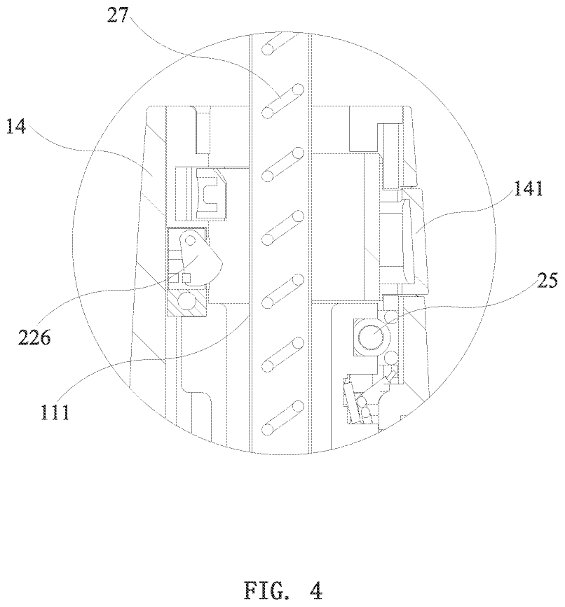

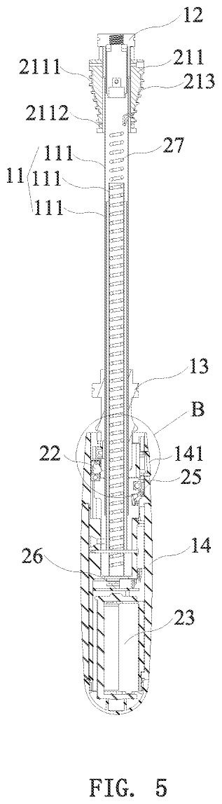

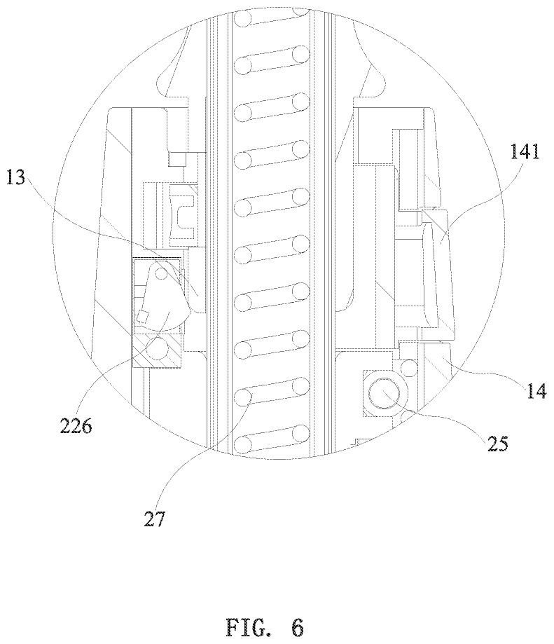

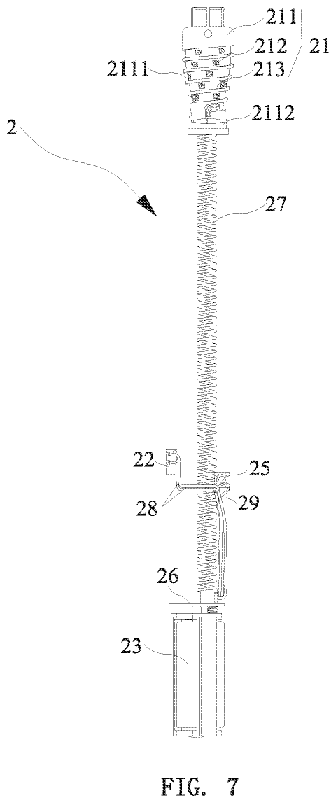

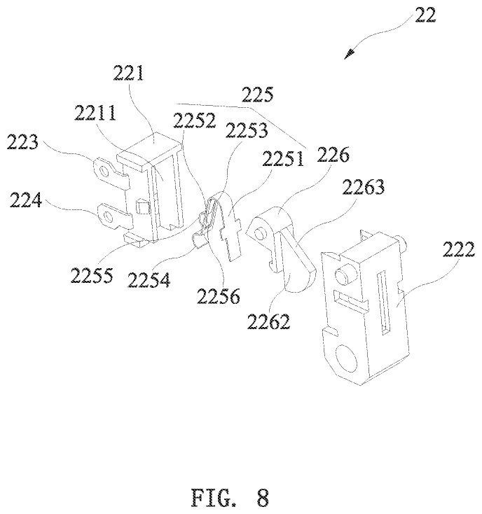

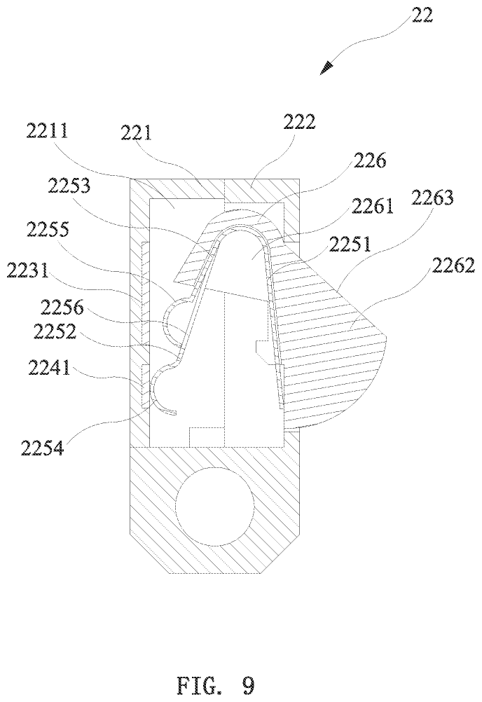

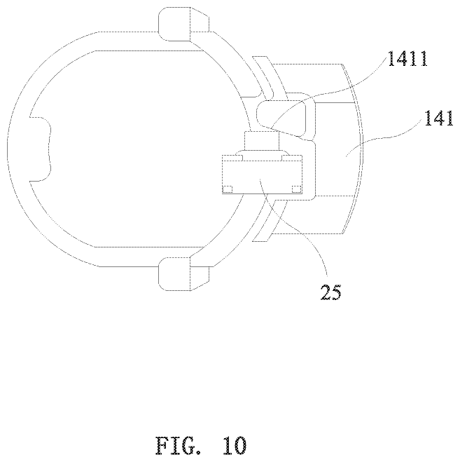

As shown in FIGS. 1 to 11, the present invention discloses an illuminating umbrella, comprising an umbrella body 1, The umbrella body 1 includes a shaft 11, an upper hub 12 fixed to an upper end of the shaft 11, a lower hub 13 movably fitted to the shaft 11, an umbrella handle 14 fixed to a lower end of the shaft 11, and an umbrella frame 15 hingedly connected to the upper hub 12 and the lower hub 13. The umbrella frame 15 is configured to support an umbrella fabric.

As shown in FIGS. 1 to 11, the illuminating umbrella of the present invention further comprises an illuminating device 2, The illuminating device 2 provides an illuminating function, so that the user can use the umbrella in an environment with insufficient light. As shown in FIGS. 1 to 9, the illuminating device 2 includes an illuminating body 21, a main switch 22 for controlling the illuminating body 21 to illuminate or not to illuminate, and a battery 23 for supplying power to the illuminating body 21. The illuminating body 21 is fitted to the shaft 11. After the illuminating umbrella of the present invention is unfolded, the illuminating body 21 illuminates the space under the umbrella frame 15, so that the user can view articles when the umbrella is used in an environment with insufficient lip it.

In the present invention, the main switch 22 of the illuminating device 2 is fitted to the umbrella body 1. The main switch 22 may be directly fitted to the umbrella body 1, or indirectly fitted to the umbrella body 1. The lower hub 13 of the umbrella body 1 movably presses the main switch 22 for controlling the main switch 22 to be connected or disconnected turned. The main switch 22 is a tact switch. Connection or disconnection of the main switch 22 controls the illuminating body 21 to illuminate or not to illuminate. In this way, the main switch 22 automatically controls the illuminating body 21 to be turned on when the umbrella is unfolded, and the main switch 22 automatically controls the illuminating body 21 to be turned off when the umbrella is folded.

In the present invention, the illuminating device 2 further includes a controller 24. The controller 24 is electrically connected to the illuminating body 21 and the main switch 22. The battery 23 supplies power to the controller 24. The controller 24 controls the illuminating body 21 to illuminate or not to illuminate according to connection or disconnection of the main switch 22. In this way, the main switch 22 controls the illuminating body 21 through the controller 24. The controller 24 may be fitted to the umbrella handle 14 of the umbrella body 1. It should be noted that the main switch 22 of the present invention also controls the battery 23 to supply power to the illuminating body 21, so as to control the illuminating body 21 to illuminate or not to illuminate.

In the present invention, the main switch 22 may include a mounting seat 221, a mounting cover 222, a first pin 223, a second pin 224, an electrically-conductive elastic plate 225, and a press member 226. The mounting seat 221 is fined to the umbrella body 1 for the main switch 22 to be titled to the umbrella body 1. One side of the mounting seat 221 is formed with a mounting groove 2211. The mounting cover 222 is installed to the mounting seat 221 and covers the side opening of the mounting groove 2211. The press member 226 is rotatably fitted to the mounting groove 2211 of the mounting seat 221. The press member 226 is formed with a groove 2261. One side of the press member 226 is provided with a press portion 2262 that movably extends out of the mounting cover 222. The press portion 2262 has an inclined surface 2263 on its outer side. The first pin 223 and the second pin 224 are configured for electrical connection with the controller 24 through wires. The connection or disconnection of the first pin 223 and the second pin 224 is to connect or disconnect the main switch 22. The first pin 223 and the second pin 224 are mounted to the mounting seat 221. The first pin 223 is provided with a first contact 2231 located on an inner end surface of the mounting groove 2211. The second pin 224 is provided with a second contact 2241 located on the inner end surface of the mounting groove 2211, The electrically-conductive elastic plate 225 includes a first elastic plate 2251, a second elastic plate 2252 and a third elastic plate 2253 that are integrally formed, A first end of the first elastic plate 2251 is connected to a first end of the second elastic plate 2252. A second end of the first elastic plate 2251 and a second end of the second elastic plate 2252 are separated from each other. The second end of the second elastic plate 2252 is provided with an immovable electrically-conductive portion 2254. An opening 2256 is formed in a middle portion of the second elastic plate 2252. A first end of the third elastic plate 2253 is connected to a side wall of the opening 2256 of the second elastic plate 2252 close to the first end of the first elastic plate 2251. A second end of the third elastic plate 2253 is provided with a movable electrically-conductive portion 2255. The first end of the first elastic plate 2251 and the first end of the second elastic plate 2252 are fitted into the groove 26111 of the press member 261. An inner side wall of the groove 2611 of the press member 261, away from the inner end surface of the mounting groove 2211, is in contact with the first elastic plate 2251. An opposing inner side wall of the groove 2611 of the press member 261, close to the inner end surface of the mounting groove 2211, is in contact with the second elastic plate 2252 and the third elastic plate 2253, The immovable electrically-conductive portion 2254 of the second elastic plate 2252 is in contact with the second contact 2241. The movable electrically-conductive portion 2255 of the third elastic plate 2253 is movable to be in contact with the first contact 2231. The lower hub 13 movably presses the inclined surface 2263 of the press member 226 to drive the press member 226 to rotate. The lower hub 13 presses the inclined surface 2263 of the press member 226 to drive the press member 226 to rotate clockwise, so that the press member 226 drives the first elastic plate 2251 to deform toward the inner end surface of the mounting groove 2211. When the first elastic plate 2251 is deformed toward the inner end surface of the mounting groove 2211, the third elastic plate 2253 is also deformed toward the inner end surface of the mounting groove 2211, so that the movable electrically-conductive portion 2255 of the third elastic plate 2253 is moved to be in contact with the first contact 2231. The first pin 223 and the second pin 224 are electrically conducted through the electrically-conductive elastic plate 225, so that the main switch 22 is electrically conducted. When the lower hub 13 releases the inclined surface 2263 of the press member 226, the first elastic plate 2251 and the third elastic plate 2253 are returned, so that the movable electrically-conductive portion 2255 of the third elastic plate 2253 is separated from the first contact 2231 and the press member 226 is rotated counterclockwise to be returned. At this time, the first pin 223 and the second pin 224 are disconnected, so that the main switch 22 is disconnected.

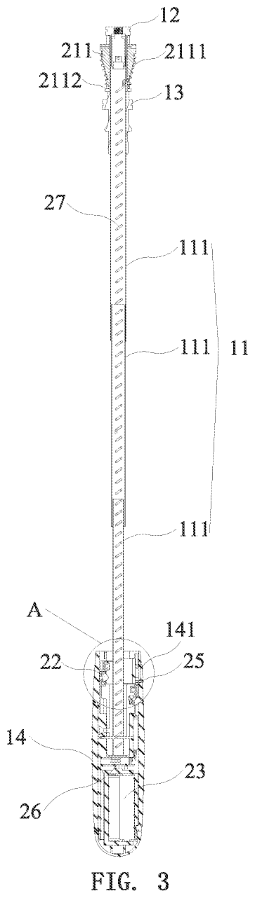

In the present invention, as shown in FIGS. 3 to 6, the main switch 22 is fitted to the umbrella handle 14 of the umbrella body 1. In this way, when the illuminating umbrella of the present invention is unfolded, the lower hub 13 releases the main switch 22 so that the main switch 22 is disconnected. At this time, the controller 24 controls the illuminating body 21 to light up, so that the illuminating body 21 automatically lights up when the umbrella is unfolded. When the illuminating umbrella of the present invention is folded, the lower huh 13 presses the main switch 22 so that the main switch 22 is connected. At this time, the controller 24 controls the illuminating body 21 to be turned off, so that the illuminating body 21 is automatically turned off when the umbrella is folded. The main switch 22 may be fitted to the upper portion of the shaft 11 of the umbrella body 1, and the main switch 22 is located above the lower hub 13. In this way, when the illuminating umbrella of the present invention is unfolded, the lower hub 13 presses the main switch 22 so that the main switch 22 is connected. At this time, the controller 24 controls the illuminating body 21 to light up, so that the illuminating body 21 automatically lights up when the umbrella is unfolded. When the illuminating umbrella of the present invention is folded, the lower hub 13 releases the main switch 22 so that the main switch 22 is disconnected. At this time, the controller 24 controls the illuminating body 21 to be turned off, so that the ting body 21 is automatically turned off when the umbrella is folded.

In the present invention, the illuminating device 2 may further include a secondary switch 25. The secondary switch 25 is electrically connected to the controller 24. The controller 24 controls the illuminating body 21 to illuminate or not to illuminate according to connection or disconnection of the secondary switch 25. In this way; after the illuminating umbrella of the present invention is unfolded, the user can control the secondary switch 25 to be turned on or not, so that the controller 24 can control the illuminating body 21 to illuminate or not to illuminate. The user can turn off the illuminating body 21 when holding an umbrella in a better light environment, so as to reduce power consumption. The secondary switch 25 may be fitted to the umbrella handle 14 of the umbrella body 1 to facilitate the user to operate the secondary switch 25. The umbrella handle 14 may be provided with a button 141 for buckling the lower hub 13. By means of the button 141, the illuminating umbrella of the present invention can be stably kept in a folded state. The secondary switch 25 is also a tact switch, Each time the secondary switch 25 is pressed, the controller 24 controls the illuminating body 21 to switch once. The secondary switch 25 may be fitted in the umbrella handle 14. The button 141 movably presses the press portion of the secondary switch 25 to control the secondary switch 25 to be connected or disconnected. The moving direction of the button 141 may be perpendicular to the moving direction of the press portion of the secondary switch 25. The button 141 has an inclined surface 1411 to movably press the press portion oldie tact switch. When the button 141 is pressed, the inclined surface 1411 will abut against the press portion of the secondary switch 25 to press the press portion of the secondary switch 25. In the present invention, the secondary switch 25 is pressed through the button 141, so that the secondary switch 25 is hidden in the umbrella handle 14, thereby making the umbrella more beautiful in appearance.

In the present invention, the illuminating body 21 includes a light holder 211 and an illuminating light 212 fitted on the light holder 211. The light holder 211 is fitted to the shaft 11 for the illuminating body 21 to be fitted to the shaft 11. The illumination of the illuminating body 21 refers to the illumination of the illuminating light 212. The main switch 22 controls the illuminating light 212 of the illuminating body 21 to illuminate or not to illuminate. The battery 23 is configured to supply power to the illuminating light 212 of the illuminating body 21. The light holder 211 is fixed to the shaft 11, and the light holder 211 is located between the upper hub 12 and the lower hub 13. In this way, the light holder 211 will not interfere with the movement of the lower hub 13. The light holder 211 may be arranged separately from the upper hub 12 or integrated with the upper hub 12. A lower end of the light holder 211 is fitted with an elastic buffer sleeve 2112. The elastic buffer sleeve 2112 reduces the impact on the light holder 211 when the umbrella is unfolded, thereby avoiding damage to the illuminating light 212 and reducing noise when the umbrella is unfolded. It should be noted diet the light holder 211 may be directly made of an elastic material (such as rubber). This can avoid damage to the illuminating light 212 and reduce noise when the umbrella is unfolded.

In the present invention, a light strip 213 is wound on the light holder 211 of the illuminating body 21, and a plurality of illuminating lights 212 are provided on the light strip 213 to increase the illumination area of the illuminating body 21. A spiral groove 2111 is formed on the outer wall of the light holder 211. The light strip 213 is fitted in the spiral groove 2111 so that the light strip 213 is wound on the light holder 211, The light strip 213 may be glued or screwed to the light holder 211.

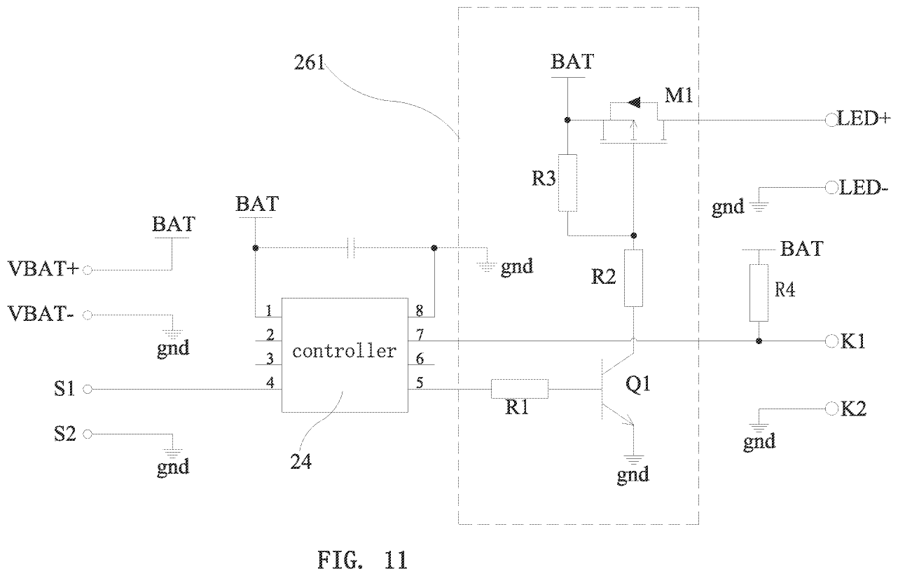

In the present invention, the controller 24 is arranged on a control circuit board 26. The control circuit board 26 is fitted in the umbrella handle 14 of the umbrella body 1. The control circuit board 26 is provided with a switch control circuit 261. The controller 24 controls the illuminating light 212 of the illuminating body 21 to illuminate or not to illuminate through the switch control circuit 261. The main switch 22, the secondary switch 25 and the illuminating light 212 of the illuminating body 21 are electrically connected to the control circuit board 26 to realize the electrical connection between the main switch 22, the secondary switch 25 and the illuminating light 212 of the illuminating body 21 and the controller 24. Referring to FIG. 11, the control circuit board 26 is provided with a positive power supply terminal VBAT+, a negative power supply terminal VBAT−, a first main switch terminal S1, a second main switch terminal S2, a first secondary switch terminal K1, a second secondary switch terminal K2, a positive terminal LED+, and a negative terminal LED−. The positive power supply terminal VBAT+ and the negative power supply terminal VBAT− are electrically connected to positive and negative terminals of the battery 23 to access the power supply of the battery 23, The first main switch terminal S1 and the second main switch terminal S2 are electrically connected to the two contacts of the main switch 22, respectively. The first secondary switch terminal K1 and the second secondary switch terminal. K2 are electrically connected to the two contacts of the secondary switch 25, respectively. The positive terminal LED+ and the negative terminal LED+ are electrically connected to positive and negative terminals of the illuminating light 212 of the illuminating body 21, respectively. The negative power supply terminal VBAT− is electrically, connected to the second main switch terminal S2, the second secondary switch terminal K2 and the negative terminal LED−. The first secondary switch terminal K1 is electrically connected to the positive power supply terminal VBAT+ through a fourth resistor R4. The power terminal and the ground terminal of the controller 24 are respectively electrically connected to the positive power supply terminal VBAT+ and the negative power supply terminal VBAT− to access the power supply of the battery 23. The two input terminals of the controller 24 are electrically connected to the first main switch terminal S1 and the first secondary switch terminal K1, respectively, so that the controller 24 can access the signals generated by the main switch 22 and the secondary switch 25. The controller 24 is electrically connected to the positive terminal LED+ through the switch control circuit 261. The switch control circuit 261 includes a first resistor R1, a second resistor R2, a third resistor R3, a transistor Q1 and a MOS transistor M1. One end of the first resistor R1 is electrically connected to an output terminal of the controller 24, and another end of the first resistor R1 is electrically connected to a base of the transistor Q1. An emitter of the transistor Q1 is electrically connected to the negative power supply terminal VBAT−. A collector of the transistor Q1 is electrically connected to one end of the second resistor R2. Another end of the second resistor R2 is electrically connected to one end of the third resistor R3 and a gate of the MOS transistor M1. Another end of the third resistor R3 and a source of the MOS transistor M1 are electrically connected to the positive power supply terminal VBAF+. A drain of the MOS transistor M1 is electrically connected to the positive terminal LED+.

As shown in FIGS. 1 to 6, the illuminating umbrella of the present invention is a folding umbrella. The shaft 11 of the umbrella body 1 includes at least two rods 111 that are insertedly connected so that the shaft 11 can be telescoped. The upper hub 12 is fixed to the upper end of the topmost rod 111 of the shaft 11. The light holder 12 is fixed to the topmost rod 111 of the shaft 11, The topmost rod 111 of the shaft 11 is provided with a buckle portion 1111 for buckling the lower hub 13 so that the illuminating umbrella can be kept in an unfolded state. The umbrella handle 14 is fixed to the bottommost rod 111 of the shaft 11. The illuminating light 212 of the illuminating body 21 is electrically connected to the control circuit board 26 through connecting wire 27 inserted in the shaft 11. The connecting wire 27 is a telescopic wire so that the connecting wire 27 can be extended and retracted along with the extension and retraction of the shaft 11, thereby ensuring that the shaft 11 can be extended and retracted normally. The telescopic wire is provided with a spiral structure for the telescopic wire to be extended and retracted. In the present invention, both the main switch 22 and the secondary switch 25 may be installed in the umbrella handle 14 of the umbrella body 1. The main switch 22 and the secondary switch 25 are electrically connected to the control circuit board 26 through a main switch wire 28 and a secondary switch wire 29, respectively. It should be noted that if the main switch 22 is fitted to the topmost rod 111 of the shaft 11 of the umbrella body 1, that is, the main switch 22 is fitted to the upper portion of the shaft 11 of the umbrella body 1, and the main switch 22 is located above the lower hub 13, the main switch 22 is electrically connected to the control circuit board 26 through the connecting wire 27.

It should be noted that the illuminating umbrella of the present invention may be a straight bone umbrella. For the straight bone umbrella, the illuminating umbrella further includes a middle hub 16 movably fitted to the shaft 11 and a spring located between the middle hub 16 and the lower hub 14. The spring is sleeved on the shaft 11, The middle hub 16 is hinged to the umbrella frame 15, When the button 141 is disengaged from the lower hub 13, the spring drives the illuminating umbrella to be unfolded, so that the user can quickly unfold the umbrella.

It should be noted that, in the present invention, the various components of the illuminating device 2 are not limited to the above-mentioned arrangement in a separate manner. The components of the illuminating device 2 may be assembled to be an integral component and then installed to the shaft 11. In this way, the installation of the illuminating device 2 is more convenient, and the installation position of the illuminating device 2 is more optional. For example, the ilk urinating device 2 may be directly connected to the lower hub 13 so that the illuminating device 2 is moved along with the lower hub 13.

Although particular embodiments of the present invention have been described in detail for purposes of illustration, various modifications and enhancements may be made without departing from the spirit and scope of the present invention. Accordingly, the present invention is not to be limited except as by the appended claims.

1. An illuminating umbrella, comprising an umbrella body and an illuminating device;
the umbrella body including a shaft, an upper hub fixed to an upper end of the shaft, a lower hub movably fitted to the shaft, an umbrella handle fixed to a lower end of the shaft, and an umbrella frame hingedly connected to the upper hub and the lower hub;
the illuminating device including an illuminating body, a main switch for controlling the illuminating body to illuminate or not to illuminate, and a battery for supplying power to the illuminating body; the illuminating body being fitted to the shaft;
wherein the umbrella body comprises a foldable structure that comprises at least two tubular rods telescopically connected together to form the shaft and wherein the illuminating body of the illuminating device is electrically connected to the battery by a connecting wire extending through interiors of the at least two tubular rods, the connecting wire comprising at least a section in a spiral form for selective extension in the interiors of the at least two tubular rods to accommodate a change of a length of the shaft in response to telescopic extension of the shaft.

2. The illuminating umbrella as claimed in claim 1, wherein the illuminating body includes a light holder and an illuminating light fitted to the light holder, the light holder is fitted to the shaft; the main switch controls the illuminating light of the illuminating body to illuminate or not to illuminate, and the battery is configured to supply power to the illuminating light of the illuminating body.

3. The illuminating umbrella as claimed in claim 2, wherein the light holder of the illuminating body is fixed to the shaft, and the light holder is located between the upper hub and the lower hub.

4. The illuminating umbrella as claimed in claim 3, wherein a lower end of the light holder is fitted with an elastic buffer sleeve.

5. The illuminating umbrella as claimed in claim 2, wherein a light strip is wound on the light holder, and a plurality of illuminating lights are provided on the light strip.

6. The illuminating umbrella as claimed in claim 5, wherein a spiral groove is formed on an outer wall of the light holder, and the light strip is fitted in the spiral groove.

7. The illuminating umbrella as claimed in claim 1, wherein the main switch is fitted to the umbrella body; the lower hub of the umbrella body movably presses the main switch for controlling the main switch to be connected or disconnected; the main switch is a tact switch, connection or disconnection of the main switch controls the illuminating body to illuminate or not to illuminate.

8. The illuminating umbrella as claimed in claim 7, wherein the illuminating device further includes a controller, the controller is electrically connected to the illuminating body and the main switch, the battery supplies power to the controller, the controller controls the illuminating body to illuminate or not to illuminate according to connection or disconnection of the main switch.

9. The illuminating umbrella as claimed in claim 8, wherein the illuminating device further includes a secondary switch, the secondary switch is electrically connected to the controller; the controller controls the illuminating body to illuminate or not to illuminate according to connection or disconnection of the secondary switch.

10. The illuminating umbrella as claimed in claim 9, wherein the secondary switch is fitted to the umbrella handle of the umbrella body.

11. The illuminating umbrella as claimed in claim 9, wherein the controller is arranged on a control circuit board, the control circuit board is fitted to the umbrella body; the control circuit board includes a switch control circuit, the controller controls the illuminating body to illuminate or not to illuminate through the switch control circuit, the main switch, the secondary switch and the illuminating body are electrically connected to the control circuit board.

12. The illuminating umbrella as claimed in claim 11, wherein the control circuit board further includes a positive power supply terminal, a negative power supply terminal, a first main switch terminal, a second main switch terminal, a first secondary switch terminal, a second secondary switch terminal, a positive terminal, and a negative terminal; the positive power supply terminal and the negative power supply terminal are electrically connected to positive and negative terminals of the battery, the first main switch terminal and the second main switch terminal are electrically connected to the main switch, the first secondary switch terminal and the second secondary switch terminal are electrically connected to the secondary switch, the positive terminal and the negative terminal are electrically connected to positive and negative terminals of the illuminating light of the illuminating body respectively, the negative power supply terminal is electrically connected to the second main switch terminal, the second secondary switch terminal and the negative terminal;
a power terminal and a ground terminal of the controller are electrically connected to the positive power supply terminal and the negative power supply terminal respectively, two input terminals of the controller are electrically connected to the first main switch terminal and the first secondary switch terminal respectively; the controller is electrically connected to the positive terminal through the switch control circuit.

13. The illuminating umbrella as claimed in claim 12, wherein the switch control circuit includes a first resistor, a second resistor, a third resistor, a transistor and a MOS transistor; one end of the first resistor is electrically connected to an output terminal of the controller, another end of the first resistor is electrically connected to a base of the transistor, an emitter of the transistor is electrically connected to the negative power supply terminal, a collector of the transistor is electrically connected to one end of the second resistor, another end of the second resistor is electrically connected to one end of the third resistor and a gate of the MOS transistor, another end of the third resistor and a source of the MOS transistor are electrically connected to the positive power supply terminal, a drain of the MOS transistor is electrically connected to the positive terminal.

14. The illuminating umbrella as claimed in claim 7, wherein the main switch includes a mounting seat, a mounting cover, a first pin, a second pin, an electrically-conductive elastic plate, and a press member;
the mounting seat is fitted to the umbrella body, one side of the mounting seat is formed with a mounting groove, the mounting cover is installed to the mounting seat and covers a side opening of the mounting groove; the press member is rotatably fitted to the mounting groove of the mounting seat, the press member is formed with a groove, one side of the press member is provided with a press portion that movably extends out of the mounting cover, the press portion has an inclined surface on its outer side;
the first pin and the second pin are mounted to the mounting seat, connection or disconnection of the first pin and the second pin is to connect or disconnect the main switch; the first pin is provided with a first contact located on an inner end surface of the mounting groove, the second pin is provided with a second contact located on the inner end surface of the mounting groove;
the electrically-conductive elastic plate includes a first elastic plate, a second elastic plate and a third elastic plate that are integrally formed, a first end of the first elastic plate is connected to a first end of the second elastic plate, a second end of the first elastic plate and a second end of the second elastic plate are separated from each other, the second end of the second elastic plate is provided with an immovable electrically-conductive portion, an opening is formed in a middle portion of the second elastic plate; a first end of the third elastic plate is connected to a side wall of the opening of the second elastic plate close to the first end of the first elastic plate, a second end of the third elastic plate is provided with a movable electrically-conductive portion;
the first end of the first elastic plate and the first end of the second elastic plate are fitted into the groove of the press member, an inner side wall of the groove of the press member, away from the inner end surface of the mounting groove, is in contact with the first elastic plate, an opposing inner side wall of the groove of the press member, close to the inner end surface of the mounting groove, is in contact with the second elastic plate and the third elastic plate, the immovable electrically-conductive portion of the second elastic plate is in contact with the second contact, the movable electrically-conductive portion of the third elastic plate is movable to be in contact with the first contact;
the lower hub movably presses the inclined surface of the press member to drive the press member to rotate.
